(19) United States
(12) Patent Application Publication
(10) Pub. No.: US 2002/0149933 A1
(43) Pub. Date: Oct. 17, 2002

(54) Flexible circuit board with LED lighting

(76) Inventors: Roy Archer, Ocoee, FL (US); Kevin A. Furry, Folsom, CA (US)

Correspondence Address: BEUSSE, BROWNLEE, BOWDOIN & WOLTER, P. A., 390 NORTH ORANGE AVENUE, SUITE 2500, ORLANDO, FL, 32801, US

(21) Appl. No.: 10/105,049

(22) Filed: Mar. 21, 2002

Related U.S. Application Data
(60) Provisional application No. 60/277,715, filed on Mar. 21, 2001.

(51) Int. Cl. F21V 33/00

(52) U.S. Cl. 362/234; 362/249; 362/800

(57) ABSTRACT

A lighting apparatus that includes a flexible circuit board having a plurality of conductive terminals and at least one electronic component attached thereto such that the lengths of the terminals and component are substantially perpendicular to the longitudinal axis of the circuit board. A plurality of light emitting elements, such as light emitting diodes (LED), is connected to the conductive terminals. The conductive terminals and corresponding LED leads may be located on one planar surface of the circuit board or may be distributed along both planar surfaces. Each one of a pair of the conductive terminals may be located on opposite surfaces of the circuit board so that the leads from an LED will straddle an upper edge of the circuit board. A method for installing a lighting apparatus includes providing a mounting means that will hold the flexible apparatus so that it is in a substantially upright position. The mounting means may include a plurality of slots so that the mounting means is flexible and conform to a variety of linear or non-linear shapes.

This application claims the benefit of U.S. patent application Ser. No. 60,266,354 filed Mar. 21, 2001.

### BACKGROUND OF THE INVENTION

The present invention relates to low voltage lighting systems and, more particularly, to multicolor illumination systems with flexible supports for forming shaped configurations of lights.

Backlit devices such as signs, cove lighting and pool lighting often utilize various configurations of lights (or lamps) to follow predetermined paths that may have linear portions and/or non-linear portions such as bends. For example, signs are commonly made with “channel letters” which are backlit. It is known to achieve such backlighting by mounting light bulbs behind the letters so that light either illuminates opaque lettering in a transparent or translucent face or shines through translucent letters in an opaque face. In either case, the bulb placement produces bright areas at the bulb locations with less bright areas away from the bulb location.

Similarly, it is known to employ commercially available round top light emitting diodes (LED) for backlighting. However, round top LEDs are also known to produce bright spots, which detract from the aesthetics of the backlighting effect. Backlighting is most effective when there is a wide angle of evenly distributed light to fill the structure being backlit. Chip-type LEDs have been used to overcome the creation of bright spots principally because of their wide viewing angle. One difficulty encountered with using chip-type LEDs on a standard circuit board is that they tend to break or come loose when the board is flexed due to the manner by which they are attached to the board. Conventional LEDs may also break, become dislodged or inhibit the flexibility of a standard circuit board when attached in a conventional manner. For example, conventional LEDs may be affixed to a circuit board so the body of the LED is perpendicular to one of the board's planar surfaces. If the base of the LED is affixed to the surface of the board with an epoxy or adhesive then the surface area of the board where the LED is affixed becomes more rigid and the board loses some of its flexibility. LEDs affixed in this manner are susceptible to breakage or coming loose when the board is flexed. An alternate method of backlighting uses fiber-optic cables to deliver light from a remote source to the device to be lit. Diffusing lenses may be used at the cable end to spread the light and minimize the bright areas characteristic of bulb lighting.

Backlighting and other needs for lighting effects frequently require a range of color and light intensities. They may also require that the housing or supporting structure for the lights be flexible so that the lights may conform to a variety of shapes or patterns during installation in order to achieve a desired illuminating effect. Also, it may be desirable to have the lights connected with a flexible base so the lights extend perpendicular from a planar surface of the base for specific applications. It is known to configure flexible “strips” of lights in various manners. For example, U.S. Pat. No. 4,597,033 to Meggs. et al. discloses a flexible elongated lighting system adapted for use primarily as an emergency lighting system. This lighting system comprises an elongated flexible waterproof housing member that is capable of a directional transmission of light towards an optimum predetermined field angle. The housing member is transparent and can be bent to define a subjective outline of an exit. A plurality of individual lighting elements is electrically mounted in parallel in the housing member and spaced along a substantial portion of its length. The housing member is provided with a variable thickness upper portion to optimize both refraction and reflection of the generated light and with a lower portion to facilitate the mounting and positioning of the lighting elements along the length of the housing member and also to a support structure. The lighting elements may be light emitting diodes.

Another example of a flexible lighting array is disclosed in U.S. Pat. No. 4,173,035 to Hoty, which discloses a tape strip having a plurality of light emitting diodes connected therewith to create a moving light display. The strip includes a plurality of light emitting diodes extending perpendicularly from one planar surface of the tape. The diode leads are inserted into a plurality of apertures and soldered and electrically connected to printed circuits. Another light strip disclosed in U.S. Pat. No. 5,746,497 to Machida describes a row of light emitting diodes arranged along the edge of a base plate rather than extending from a planar surface. Adjacent diodes share common leads that extend perpendicularly to the longitudinal axis of the strip. The leads are on one side of the strip and are connected by a conducting material that extends as a flat strip parallel with the longitudinal axis of the base plate. In this respect, the base plate is not susceptible to being flexed to conform to various configurations, if desired, because the connections between the leads could be damaged or break due to being flexed transverse to their longitudinal axis. This may cause an undesired failure of one or more of the lights in the row.

In view of the above, it would be advantageous to provide a flexible strip with lighting elements attached thereto that could conform to a variety of shapes and contours while ensuring the integrity of the electrical connections. Providing the flexible strip with high intensity lighting elements having a wide viewing angel for a more even distribution of light is desirable. It would also be advantageous to provide a means for mounting a flexible strip to a support surface and allow for a plurality of flexible strips to be connected mechanically and electrically to form a longer assembly if desired.

### SUMMARY OF THE INVENTION

The present invention provides a flexible strip that may have a plurality of lighting elements advantageously attached thereto so that the strip may conform to a wide variety of shapes without impairing the integrity of electrical connections between lighting elements. In one exemplary embodiment light-emitting diodes (LEDs) may be provided as the lighting elements. One aspect of the present invention allows for a system for mounting and installing LEDs in various configurations. A flexible printed circuit board such as a commercially available PC board made of fiberglass, for example, may be provided to which a plurality of LEDs may be connected in accordance with one aspect of the present invention. The LEDs may be arranged with a fixed amount of space between sequential LEDs to provide an evenly distributed lighting effect. Other embodiments may space the LEDs in various arrangements.

Each flexible PC board may be provided at one or both ends with a connector allowing it to be connected mechanically and electrically in series with other boards to form longer assemblies as desired. A single board or a plurality of boards connected in series is advantageous in that they may be mounted on one edge, that is, so the board is in an upright position. The light emitting elements may be connected to the board so they extend longitudinally from the board's upper edge when installed. This configuration advantageously conforms to fit letters for signs, cove lighting, pool lighting, channel letters, twisting about a column and other applications requiring linear and/or non-linear lighting. It also allows for the flexible board to be easily mounted to a support surface that is substantially parallel with the base. If desired, two or more boards may be mounted in parallel to accommodate wide lettering, for example.

Each flexible circuit board may be produced in a conventional manner with electrical conductors formed on one or both planar surfaces of the board in accordance with one aspect of the present invention. The layout of the board may be designed such that any electrical component, such as the electrical conductors or a resistor, mounted to the board is positioned so its lengthwise axis is generally transverse or perpendicular to the longitudinal axis of the board. This orientation is advantageous in that it minimizes any stress applied to the components when the board is flexed or bent about an axis substantially normal to the board's longitudinal axis. That is, when the board is flexed along its longitudinal axis the stress on the components is minimize due to their orientation. In contrast, if an electrical component were mounted to the board with its length generally parallel to the board's longitudinal axis the component may resist bending when the board is flexed or bent in this manner. This may cause damage to or break the component.

Electrical conductors may be provided on the board and may include a plurality of pads or terminations adapted for electrical connection to conductors of a light-emitting element such as LEDs, for example. Each LED typically has a pair of corresponding conductors or leads in the form of small gauge wire. The LED leads may be soldered to the terminations on the flexible board. The terminations may be arranged in adjacent pairs on the flexible board such that the LEDs can be positioned with their respective leads on corresponding terminations and soldered in place. In this exemplary embodiment, each termination's length may be oriented substantially transverse to the longitudinal axis of the flexible circuit board to minimize stress applied to a termination when the board is flexed or bent. Each termination may desirably extend so that a distal end is proximate the upper edge of the board. This arrangement allows the connected LEDs to extend longitudinally from the upper edge of the board. Both LED leads may be connected to terminations formed on the same side, or planar surface, of the board if desired.

In another exemplary embodiment, the electrical conductors may be arranged on both or opposite planar surfaces of the board such that each termination of a pair of terminations is located on a planar surface of the circuit board opposite the other. In other words, one termination is on one planar surface of the board and the matching termination for connecting to a lighting element is on the opposite planar surface. In this respect, an LED may be positioned to extend from an edge of the board where one LED lead is connected to each surface of the board. This aspect, as well as connecting both LED leads to the same side of a board, is advantageous in forming the board along bends, around corners or following cursive lettering, for example, while maintaining the integrity of the electrical connections and avoiding breakage of the LED.

One aspect of the present invention allows for means for mounting the flexible circuit board to a supporting surface such as one that is oriented parallel to a planar surface of the flexible circuit board. For example, in one embodiment the means for mounting may include a plurality of spaced apertures formed along the length of the circuit board. The apertures may be used to mount the board to a support surface using known mounting implements such as nails or screws. The apertures may also be used to hang a circuit board from hooks affixed to the support surface. Another exemplary embodiment allows for the mounting means to include an elongated structure that is adapted to firmly secure the flexible circuit board by means of a plurality of clips extending from the structure. The structure may include a plurality of slots cut into its base so that the structure is sufficiently flexible to conform to a variety of shapes. A plurality of apertures may be provided within the structure so that it may be mounted to a support surface. In this respect, one aspect of the present invention allows for a method for mounting a flexible circuit board to a support surface.

### BRIEF DESCRIPTION OF THE DRAWINGS

FIG. 1 is an exemplary embodiment of a flexible circuit board contemplated by the present invention;

FIG. 2 illustrates an exemplary embodiment of a flexible board and LED mounting arrangement;

FIG. 3 is a cross sectional view of FIG. 2 taken along line 3-3;

FIG. 4 is a perspective view of an exemplary embodiment of a mounting means contemplated by the present invention;

FIG. 5 illustrates another exemplary embodiment of a flexible circuit board secured within the mounting means of FIG. 4; and

FIG. 6. is a cross sectional view of FIG. 5 taken along line 6-6.

### DETAILED DESCRIPTION OF THE INVENTION

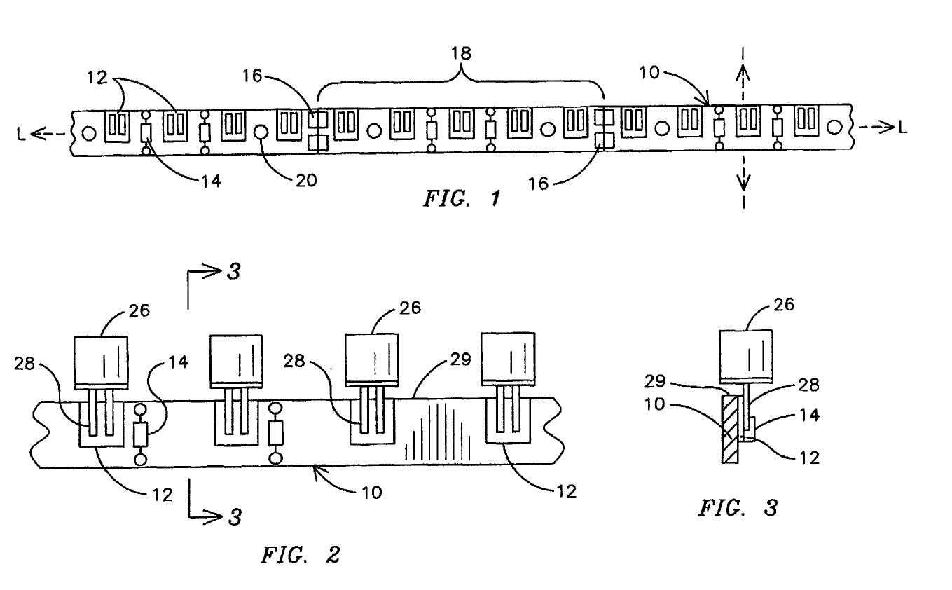

FIG. 1 illustrates an exemplary embodiment of a flexible printed circuit board of the present invention generally referred to as 10. The flexible printed circuit board 10 may be fabricated by known methods of know materials and may be a standard PC board made of fiberglass, for example. Other materials may be used provided the board 10 may be shaped into various configurations without cracking or breaking and so that any electrical components fabricated within board 10 will not become loose or dislodged from board 10 when it is flexed or bent into shape. This helps to maintain the integrity of any electrical connections affixed to the board. In one exemplary embodiment the board 10 may have a thickness in of about 0.03125 inches and a width of about 0.4 of an inch. A standard PC board with these dimensions provides sufficient flexibility in accordance with one aspect of the invention. The board 10 may be provided in varying lengths but typically may be about 20 inches long.

The board 10 may include a plurality of conductive pads or terminations 12 arranged in pairs on one planar surface of board 10, although it will be recognized that additional pairs of terminations 12, or terminal pairs, may be arranged on the opposite planar surface. In this respect, a plurality of terminations 12 may be provided on one planar surface only or on both planar surfaces of board 10. Various configurations will be readily apparent to those skilled in the art. For example, terminal pairs 12 could alternate sequentially from one surface of the board to the other along the longitudinal axis of the board 10. Similarly, groups of terminal pairs 12, such as four terminal pairs 12 grouped together for example, could alternate sequentially from one surface of the board to the other along its longitudinal axis. Board 10 may be constructed so that terminations 12 are located on one side of board 10 only or the terminations 12 may be located on both sides of board 10 simultaneously. The terminations 12 may be constructed of conventional material that provides electrical conductance to a lighting element when connected. In an exemplary embodiment of the present invention the lighting element may be an LED. Other embodiments may include different terminations depending on the lighting element. For instance, the terminations 12 could be housed in a female connector adapted to receive the male connector of a halogen lamp.

One embodiment of the present invention allows for the terminations 12 to be arranged on the board 10 so that their length or longitudinal axis [symbol] is substantially transverse or perpendicular to the longitudinal axis L of board 10. This arrangement minimizes stress on the terminations 12 when a portion of the board 10 is flexed or bent about an axis that is substantially normal to the board's 10 longitudinal axis. In one exemplary embodiment of the present invention the terminals 12 are designed to provide electrical connection with a low-voltage LED, such as LEDs 26 shown in FIG. 2. In one exemplary embodiment a flat top LED having a wide angle of about 60 degrees or greater may be used. It has been determined by the assignee of the present invention that using a flat top LED, such as those available from Agilent Technologies, significantly reduces or eliminates bright spots in the illuminating effect, which are often caused by conventional round top T1 ¾ LEDs. Using flat top LEDs arranged on board 10 in accordance with one aspect of the present invention also achieves a more even dispersion of light. It will be recognized by those skilled in the art that terminals 12 may be designed to provide electrical connection with various other types of lighting elements such as halogen bulbs or other such elements depending on the specific application.

Low voltage electronics may be provided on the board 10, for example, for powering the LEDs or a separate voltage source may be provided. The LEDs may be adapted to produce a wide range of colors. For example, LEDs may be provided with the flexible circuit board 10 to produce red, blue, green, white, orange and amber, for example, which when used in combinations may produce almost any desired color. The LEDs may be grouped by color or colors to control the illuminating effect or the flexible circuit board 10 may be provided with a plurality of LEDs that produce the same color. A computer processor may be provided for controlling the red, green and blue LEDs or for controlling any combination of LEDs to produce a desired illuminating effect. One embodiment of the present invention allows for the processor to be programmed so that a momentary low-voltage power interrupt can be used to lock a desired color for illumination. This may be accomplished by pulse width modulation. The power interrupt routine may also stop other preprogrammed routines such as those designed to produce random or planned changes in the preprogrammed illumination schemes.

One exemplary embodiment of the present invention may include electrical components such as resistors 14 where the resistors 14 may be arranged on the board 10 so that their length is substantially transverse or perpendicular to the longitudinal axis of board 10. This arrangement minimizes stress on the resistors 14 when a portion of the board 10 is flexed or bent about an axis that is substantially normal to the board's 10 longitudinal axis. The resistors 14 may be conventional surface mount or hole mount resistors, for example. One aspect of the present invention allows for resistors 14 to be located on one side of board 10 only or the resistors 14 may be located on both sides of board 10 simultaneously. Similarly, terminations 12 and resistors 14 may be fabricated in various combinations on one side of board 10 only or they may be fabricated in various combinations on both sides of board 10 simultaneously.

One exemplary embodiment of the present invention allows for board 10 to include adjacent pairs of pads 16 spaced along its longitudinal axis. Pads 16 may serve as joints where two or more segments 18 may be disconnected or joined together. For example, board 10 may be fabricated having a plurality of pads 16 in spaced relation. A notch or space may be formed between adjacent pairs of pads 16 to allow the board 10 to be cut into segments 18. This aspect of the present invention allows for the length of the board 10 to be adjusted for different applications. Each end of a segment 18 may include an adjacent pair of pads 16 that function as a means for connecting one segment 18 to another segment 18. Each segment 18 may be mechanically and electrically joined to other segments 18 by soldering adjacent pairs of pads 16 together, or by other suitable methods. Pads 16 may also function as a means for a segment 18 to be electrically connected with other components or a power source, for example. For example, an electrical connector may be affixed to the pads 16 for connecting to other devices or the devices could be connected directly to the pads 16. One or more of the pads 16 may include a hole to facilitate the connections. Each segment 18 may be about 12 inches in length or it may be other lengths as desired. In this respect, each segment 18 may accommodate approximately five pairs of terminations 12 and two resistors 14. This exemplary embodiment of the present invention allows for five LEDs to be affixed to the board 10 in each segment 18. It will be recognized by those skilled in the art that the number of terminations 12 and resistors 14 per segment 18 may vary.

Installation of one or more boards 10 may include means for mounting or affixing the board 10 in position on a support surface. For example, means for mounting board 10 to a support structure may include mounting holes or apertures such as indicated at 20 in FIG. 1 and may be provided in each segment 18. Mounting holes 20 may be spaced from the terminations 12 and resistors 14 to minimize the risk of damage to those components when the board 10 is being affixed or mounted in place. In an alternate embodiment, as will be described more fully below, it may be preferable to use another means for affixing or mounting the board 10 to a supporting structure, which may provide for an increased ability to control the board's 10 positioning and bending during installation and/or use. FIG. 2 and 3 illustrate an exemplary embodiment of the present invention where a plurality of LEDs 26 is connected to a board 10.

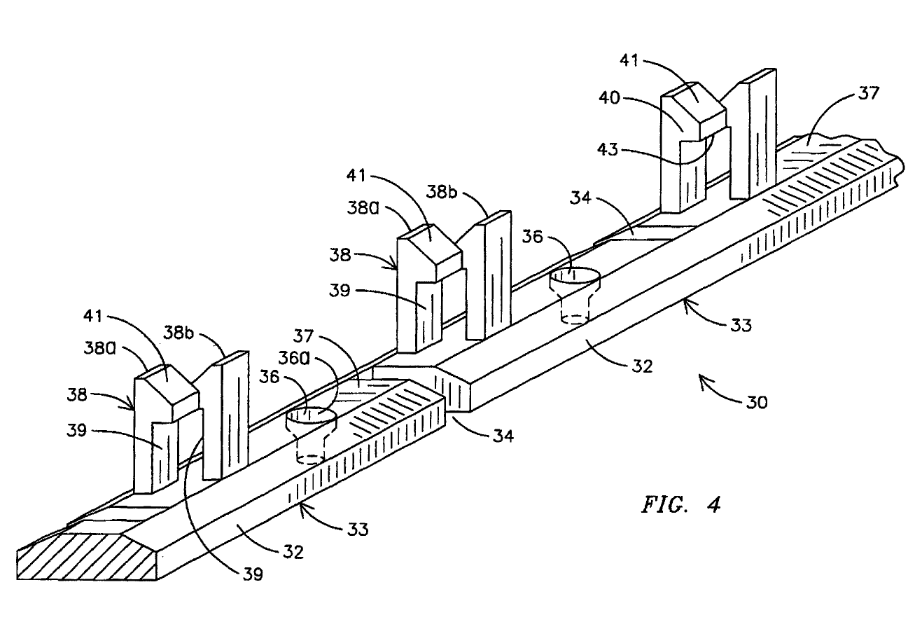

FIG. 4 shows a perspective view of one exemplary embodiment of a means for mounting the flexible board 10 and generally referred to as 30. The mounting means 30 may include a base section 32 that may have a plurality of notches 34 formed therein. The notches 34 may extend substantially but not completely across the base section 32 thereby allowing the base section 32 to be bent or flexed at the notches 34. In an alternate embodiment the base section 32 may be formed of a sufficiently flexible material and would not require notches 34. In one exemplary embodiment the notches 34 may extend across the base section 32 in opposite directions, as shown in FIG. 4, so that the base section 32 may be flexed to about the same degree in either direction. Alternate embodiments may have notches 34 extending across the base section 32 in only one direction on one side of the base section 32 if desired. Such an embodiment may be useful for forming a specific shape such as a circle or oval, for example. Other embodiments may space notches 34 in a range of patterns along the base section 32 to accommodate any specific need for forming a desired pattern. Another alternate embodiment may include a plurality of notches formed longitudinally within base section 32 or a plurality of apertures to provide sufficient flexibility to the mounting means 30.

The mounting means 30 may be constructed of a plastic or other suitable material. Mounting means 30 may include a plurality of holes or apertures 36 extending through the base section 32 for attaching the mounting means 30 to a support structure. A countersunk portion 36a may also be provided. A hole 36 may be located between each adjacent pair of notches 34 so that each segment 33 of base section 32 may be independently attached to a support surface. In an alternate embodiment, holes 36 may be formed at various locations along the longitudinal axis of base section 32. In another alternate embodiment an appropriate adhesive may be used to mount the base section 32 to a support structure rather than holes 36.

Mounting means 30 may also include means for securing board 10 to the base section 32 such as a plurality of clips 38 extending substantially perpendicular from an upper surface 37 of base section 32. The clips 38 may extend upward from the base section 32 and may be sized and shaped so as to receive and retain the flexible board 10. In one exemplary embodiment each clip 38 may include a first flexible arm 38a and a second flexible arm 38b. The first arm 38a and the second arm 38b may each have a frontal portion 39 and an overhanging portion 40. The arms 38a and 38b may be affixed to the upper surface 37 in an opposing manner so that the frontal portion 39 of first arm 38a faces the frontal portion 39 of second arm 38b. Similarly, in this exemplary embodiment the arms 38a and 38b may be situated on the upper surface 37 so that the overhanging portion 40 of each arm 38a and 38b face toward one another. Each overhanging portion 40 may include a substantially beveled portion 41 to facilitate grasping an arm 38a or 39b so that the arms may be flexed away from each other for inserting a board 10 there between. For example, an end user may place a finger or thumb on the beveled portion 41 to urge that arm away from the other to insert the board 10. It will be recognize by those skilled in the art that the means for securing the board 10 may be embodied as clips 38 or alternate structures such as being formed similar to alligator clips, hooks or the grasping end of a paper clip, for example.

In one embodiment of the present invention the first and second flexible arms 38a and 38b may be affixed to upper surface 37 so that their opposing frontal portions 39 define a space there between viewed along a longitudinal axis of the base section 32. The space may be substantially the same as the thickness of board 10. Also, each arm 38a and 38b may include a lower surface 43 that may be formed as part of the overhanging portion 40. The lower surface 43 may form a substantially right angle with the frontal portion 39. One aspect of the present invention allows for the distance between the lower surface 43 and upper surface 37 to be substantially the same as the width of board 10. The distances between the frontal portions 39 of opposing arms 38a and 38b, and the upper and lower surfaces 37 and 43 provide a secure grasp on the board 10 when inserted within the clips 38 of the mounting means 30.

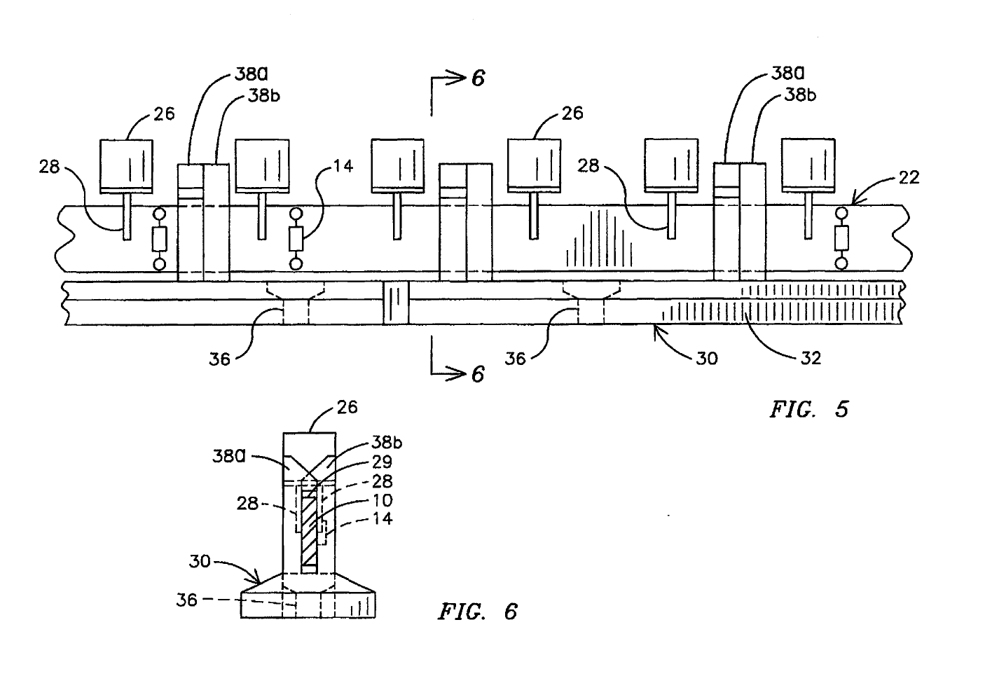

FIG. 5 illustrates a board 22, fabricated substantially the same as board 10, secured within the mounting means 30. Board 10 is secured within the mounting means 30 in the same manner as shown for board 22 in FIGS. 5 and 6. Board 22 may include one termination on one surface of board 22 and the other termination of a pair on the opposite surface of board 22 rather than both terminations of the pair being on one surface as shown on board 10 in FIG. 1. FIG. 6 illustrates an end view of board 22 where one electrical lead 28 extending from an LED 26 is connected with one of the pair of terminations 12 (not shown) on each surface of the board 22. In this respect, the electrical leads 28 straddle a top edge 29 of board 22 when connected with the terminations 12. In this exemplary embodiment the resistors 14 may be in the same or similar locations as those depicted in FIG. 1. In alternate embodiments the number and location of resistors 14 may vary as a function of the LED or other lighting element performance specifications and length of the board 10 or 22.

FIG. 5 illustrates board 22 inserted between a plurality of first arms 38a and second arms 38b on one embodiment of a mounting means 30 as shown in FIG. 4. The board 22 may be aligned within the flexible arms so that the first and second arms 38a and 38b do not exert force on or otherwise interfere with electrical components such as the resistors 14, terminations 12 or the electrical leads 28 of an LED, for example. FIG. 6 illustrates an end view of the embodiment shown in FIG. 5 with the board 22 held by a pair of arms 38a and 38b.

One aspect of the present invention allows for the mounting means 30 to be affixed on a support surface first and then the flexible circuit board 10 or 22 to be inserted in the clips 38 of the mounting means 30. Other mounting methods are contemplated such as by attaching the flexible board 10 or 22 directly to a shaped surface by mounting implements such as screws or nails extending through holes 20 into the support surface. In another embodiment, the clips 38 could be affixed to separate, individual base pieces that are individually mounted to a support surface to define a pattern. Portions of the flexible circuit board 10 or 22 may then be inserted into the mounted clips 38. Still another embodiment of mounting a board 10 or 22 may include passing the board through an extruder to encapsulate the board within a mounting means similar to that shown in FIG. 4. This embodiment may have a base section that is wider than that shown in FIG. 4 so that apertures formed integral with the mounting means through which mounting screws or nails would be inserted are offset from the base section 32. This would avoid interference between the screws or nails and the flexible board 10 or 22 encapsulated within the mounting means.

The LEDs are low voltage elements and avoid the electrical hazard associated with use of regular incandescent, fluorescent or neon lighting. Color LEDs in such colors as red, green, blue, white, orange and amber are commercially available and may be used with various embodiments of the present invention. Further, the LEDs can be mounted in groups, such as red, green, blue and the intensity of each controlled individually and/or together so as to produce a broad range of perceived colors. It is contemplated that the LEDs 26 on each flexible circuit board 10 or 22 can be controlled by a local processor to produce any desired pattern of colors, both fixed and changing. Commercially available processors can be programmed to provide such color control. For example, PIC chips can be programmed using pulse width modulation at a simple level to cyclically vary the voltage applied to the LEDs to control color. The advantage of such simple, local control is that the flexible circuit board 10 or 22 having LEDs connected to it can be treated as a single module requiring only two low voltage leads to the module for power. The PIC can be programmed so that a momentary power interrupt can cycle the PIC to another operating mode, such as to maintain a fixed LED color, for example.

It will be recognized that the flexible circuit board 10 or 22 with low-voltage, controlled LED lighting can be applied to many applications where it is desirable to avoid risks associated with normal household or commercial voltages. For example, pool lighting can be simplified using an encapsulated flexible circuit board 10 or 22 with LED lamps such that water cannot get to the electrical connections at the lamps. Further, adding a PIC to control color produced by the light emitting elements may be desirable. Track lighting or channel lighting also becomes simpler to implement and avoids the risks associated with handling higher voltage lighting apparatus.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

We claim:

1) A lighting apparatus comprising:
a circuit board adapted to be flexed along a longitudinal axis, the circuit board adapted to receive an electrical current;
at least one conductive terminal disposed on the circuit board and adapted to receive at least a portion of the electrical current, the at least one conductive terminal having a longitudinal axis substantially transverse to the longitudinal axis of the circuit board to minimize stress on the at least one conductive terminal when the board is flexed; and
a light emitting element having at least one conductive lead, the light emitting element connected to and in electrical communication with the at least one conductive terminal.

2) The lighting apparatus of claim 1 further comprising:
means for mounting the circuit board to a support structure; and
means for connecting the circuit board to at least one of a power source and an electrical device.

3) The lighting apparatus of claim 1 further comprising:
an electrical component disposed on the circuit board and adapted to receive at least a portion of the electrical current, the electrical component having a longitudinal axis substantially transverse to the longitudinal axis of the circuit board to minimize stress on the electrical component when the board is flexed.

4) The lighting apparatus of claim 1 further comprising:
means for connecting the circuit board to a second circuit board.

5) The lighting apparatus of claim 2, the means for mounting comprising:
at least one aperture formed within the circuit board.

6) The lighting apparatus of claim 2, the means for mounting comprising:
a base section, the base section adapted to be flexed along a longitudinal axis to conform to a predetermined shape; and
means for securing the circuit board to the base section so the circuit board is fitted to the predetermined shape.

7) The lighting apparatus of claim 6 further comprising:
at least one notch formed within the base section for allowing the base section to be flexed.

8) The lighting apparatus of claim 6, the means for securing the circuit board to the base section comprising:
a first flexible arm extending substantially perpendicular from the base section; and
a second flexible arm extending substantially perpendicular from the base section, the first and second arms being in juxtaposition and adapted to receive a portion of the circuit board there between.

9) The lighting apparatus of claim 8 further comprising:
a first overhanging portion extending substantially perpendicular from a distal end of the first flexible arm; and
a second overhanging portion extending substantially perpendicular from a distal end of the second flexible arm, the first and second overhanging portions adapted to fit over an upper edge of the circuit board when secured between the first and second flexible arms.

10) The lighting apparatus of claim 1, the at least one conductive terminal comprising:
a first conductive lead disposed on a first planar surface of the circuit board; and
a second conductive lead disposed on the first planar surface.

11) The lighting apparatus of claim 10 wherein a distal end of the first conductive lead and a distal end of the second conductive lead are proximate an edge of the circuit board.

12) The lighting apparatus of claim 1, the at least one conductive terminal comprising:
a first conductive lead disposed on a first planar surface of the circuit board; and
a second conductive lead disposed on a second planar surface of the circuit board such that the light emitting element will straddle an edge of the circuit board when a pair of the at least one conductive lead of the light emitting element are connected to the first conducive lead and the second conductive lead of the at least one conductive terminal.

13) The lighting apparatus of claim 12 wherein a distal end of the first conductive lead and a distal end of the second conductive lead are proximate the edge of the circuit board.

14) The lighting apparatus of claim 3, the light-emitting element comprising a flat top light-emitting diode having a wide angle of at least about 60 degrees.

15) A lighting system comprising:
a plurality of circuit boards, each circuit board adapted to be flexed along a longitudinal axis and adapted to receive an electrical current;
means for mounting the plurality of circuit boards to a support structure;
a plurality of conductive terminals disposed on at least one of the plurality of circuit boards, at least one of the plurality of conductive terminals adapted to receive at least a portion of the electrical current;
means for connecting one of the plurality of circuit boards to another of the plurality of circuit boards; and
a plurality of light emitting elements connected to and in electrical communication with the plurality of conductive terminals.

16) The lighting system of claim 15 further comprising:
at least one electrical component disposed on at least one of the plurality of circuit boards and adapted to receive at least a portion of the electrical current.

17) The lighting system of claim 15, the means for mounting comprising:
at least one aperture formed within the plurality of circuit boards; and
means for connecting at least one of the plurality of circuit boards to a power supply.

18) The lighting system of claim 15, the means for mounting comprising:
a base section adapted to be flexed along a longitudinal axis so it may conform to a predetermined shape; and
means for securing the plurality of circuit boards to the base section so the plurality of circuit boards conform to the predetermined pattern.

19) The lighting system of claim 15, at least one of the plurality of conductive terminals having a longitudinal axis substantially transverse to the longitudinal axis of the circuit board to minimize stress on the conductive terminal when the board is flexed.

20) The lighting system of claim 19 further comprising:
at least one electrical component disposed on at least one of the plurality of circuit boards and adapted to receive at least a portion of the electrical current, the electrical component having a longitudinal axis substantially transverse to the longitudinal axis of the circuit board to minimize stress on the electrical component when the board is flexed.

21) The lighting system of claim 18, the means for securing the plurality of circuit boards to the base section comprising:
a plurality of clips extending from the base section, each clip comprising a first flexible arm in juxtaposition with a second flexible arm wherein a portion of the plurality of circuit boards is secured between the first and second flexible arms.

22) The lighting system of claim 21 further comprising:
a first overhanging portion extending from a distal end of the first flexible arm; and
a second overhanging portion extending from a distal end of the second flexible arm, the first and second overhanging portions adapted to fit over an edge of the plurality of flexible circuit boards when secured by the flexible arms.

23) The flexible lighting system of claim 18, the means for mounting comprising a plurality of notches formed across the base section for flexing the mounting means along its longitudinal axis.

24) The flexible lighting system of claim 15, at least one of the plurality of conductive terminals having a longitudinal axis substantially transverse to the longitudinal axis of the circuit board to minimize stress on the plurality of conductive terminals when the board is flexed.

25) The flexible lighting system of claim 24 wherein at least one of the plurality of conductive terminals comprises a first conductive lead disposed on a first surface of one of the plurality of circuit boards and a second conductive lead disposed on a second surface of the circuit board; and
at least one of the plurality of light emitting elements comprises a first lead connected to the first conductive lead and a second lead connected to the second conductive lead such that the first lead and the second lead of the light emitting element straddle an edge of one of the plurality of circuit boards.

26) A method for installing a lighting apparatus comprising the steps of:
providing a circuit board having a plurality of light emitting elements extending longitudinally from an upper edge of the circuit board;
providing a means for mounting the circuit board to a support surface;
affixing the means for mounting to the support surface; and
inserting the circuit board within the means for mounting such that a lower edge of the circuit board is proximate an upper surface of the mounting means and the circuit board is securely held in an upright position.

27) The method of claim 26 further comprising the step of:
providing the means for mounting with a plurality of clips extending from a base section of the means for mounting, the plurality of clips adapted to securely hold the circuit board.

28) The method of claim 27 further comprising the step of:
forming each of the plurality of clips with a first flexible arm in juxtaposition with a second flexible arm.

29) The method of claim 26 further comprising the step of:
forming at least one notch within the base section of the mounting means so the mounting means may conform to a predetermined pattern.

30) The method of claim 26 further comprising the step of:
providing light emitting diodes as the light emitting elements; and
connecting a first lead of each diode to a corresponding terminal on one surface of the circuit board and a second lead of each diode to a corresponding terminal on the opposite surface of the circuit board so that the first lead and second lead straddle an upper edge of the circuit board.

31) The method of claim 26 further comprising the step of:
providing the circuit board so that it may be flexed to conform to a variety of shapes.
